(19) United States
(12) Patent Application Publication
(10) Pub. No.: US 2006/0263279 A1
(43) Pub. Date: Nov. 23, 2006

(54) Adjustable path sublimator system and related method of use

(76) Inventors: Cato T. Laurencin, Earlysville, VA (US); Swaminathan Sethuraman, Kodambakkam (IN); Subhabrata Bhattacharyya, Charlottesville, VA (US); William Shoup, Charlottesville, VA (US)

Correspondence Address: UNIVERSITY OF VIRGINIA PATENT FOUNDATION, 250 WEST MAIN STREET, SUITE 300, CHARLOTTESVILLE, VA, 22902, US

(21) Appl. No.: 11/416,504

(22) Filed: Apr. 27, 2006

Related U.S. Application Data
(60) Provisional application No. 60/675,672, filed on Apr. 28, 2005.
(60) Provisional application No. 60/729,833, filed on Oct. 25, 2005.

(51) Int. Cl. B01D 7/00

(52) U.S. Cl. 422/244

(57) ABSTRACT

A sublimator device is designed where the distance between the sublimation surface and the bottom of the device to be adjusted depending on the amount of substance in the bottom of the device and the rate of sublimation without stopping the process. The device has a threaded connector on the top that allows the condenser to be advanced or receded without stopping the sublimation process. Different embodiments of the sublimator device are disclosed and indications for the use of these devices during the sublimation process are discussed.

### CROSS-REFERENCES TO RELATED APPLICATION

The present application claims priority from U.S. Provisional Patent Application Ser. 60/675,672, filed on Apr. 28, 2005, entitled “Adjustable Path Sublimators” and U.S. Provisional Patent Application Ser. 60/729,833, filed on Oct. 25, 2005, entitled “Adjustable Path Sublimator System and Related Method,” the disclosures of which are hereby incorporated herein in their entirety.

### U.S. GOVERNMENT RIGHTS

This invention was made with United States Government support under Grant No. AR 45460, awarded by National Institutes of Health. The United States Government has certain rights in the invention.

### FIELD OF THE INVENTION

This invention relates to the field of sublimation devices and methods for adjusting the proximity of the sublimate collection surface to the starting material to be sublimated.

### BACKGROUND OF THE INVENTION

Sublimation is the transformation of a vapor phase into solid phase and vice versa without the passing through a liquid phase. Sublimation is an important separation process used for the purification of chemicals. It is often used in industries and laboratories to purify volatile components from relatively non volatile components. For example, iodine is purified by heating the dark solid to a purplish vapor which condenses on a crystalline solid upon striking a cool surface.

The sublimation process can either be performed with or without a reflux. The former is called fractionation sublimation while the latter is known as simple sublimation. One of the driving forces for a sublimation process is the vapor pressure of the subliming components. Practically, there are few substances that sublime at atmospheric condition. Hence sublimation is performed at elevated temperature or lower pressure or both.

A typical laboratory scale sublimator consists of two parts—a base and a top. The base part holds the chemicals that need to be sublimated and is covered by a top part. A cold trap is fitted to the top to collect the pure solids and the sublimator is heated under vacuum.

Currently, sublimators work properly, but the distance between the bulb of the cold trap and the bottom is fixed. When chemicals are sublimated, they are transformed to the vapor phase and they crystallize on the surface of the cold trap. The crystals grow in size with time and they come in contact with the impure chemical on the base. To avoid this, the sublimation process has to be stopped and the sublimed chemicals have to be removed. When dealing with highly sensitive chemicals, stopping the reaction intermittently is a big concern and sublimators with better design are required to solve this problem.

### SUMMARY OF THE INVENTION

According to an embodiment of the present invention, sublimator designs are provided where the distance between the cold trap and the bottom can be adjusted depending on the amount of substance in the bottom and the rate of sublimation.

Further, methods for adjustable path sublimation are provided for adjusting the proximity of the sublimate collection surface to the sublimation starting material without interrupting the sublimation process or compromising the integrity of the sublimation conditions and allowing for increased and sustained yield without risk of contamination.

An aspect of various embodiments of the present invention provides a device which comprises of a vessel that contains the starting material, a heat source for heating the starting material, a sublimating surface within the vessel for collecting sublimate of the material, a port on the vessel for controlling pressure within the vessel, and the sublimating surface and the vessel are in movable relation to one another, where the moveable relationship allows the sublimating surface from making contact with the starting material in the vessel and without interrupting the sublimation process which allows for increased and sustained yields without risk of contamination.

An aspect of various embodiments of the present invention provides for a method for sublimating a suitable starting material with the starting material in a heated vessel, controlling the heat applied to the starting material, and collecting the sublimate produced from the heated starting material onto a sublimating surface, where the collected sublimate avoids contact with the starting material in the vessel without stopping the sublimation process or compromising the integrity of the sublimation environment.

The invention itself, together further objects and attendant advantages, will best be understood by reference to the following detailed description taken in conjunction with the accompanying drawings.

### BRIEF DESCRIPTION OF THE DRAWINGS

FIG. 1 is an entire view of a sublimator device of the present invention.

FIG. 2 is a view of the lower vessel of the sublimator device of the present invention.

FIG. 3 is a view of the upper vessel of the sublimator device of the present invention.

FIG. 4 is a view of the condenser of the sublimator device of the present invention.

FIG. 5 is a view of the sublimator device of the present invention at the beginning of the sublimation process.

FIG. 6 is a view of the sublimator device of the present invention at a later stage of the sublimation process.

FIG. 7 is an entire view of another sublimator device of the present invention.

FIG. 8 is a view of another sublimator device of the present invention.

### DETAILED DESCRIPTION OF THE DRAWINGS

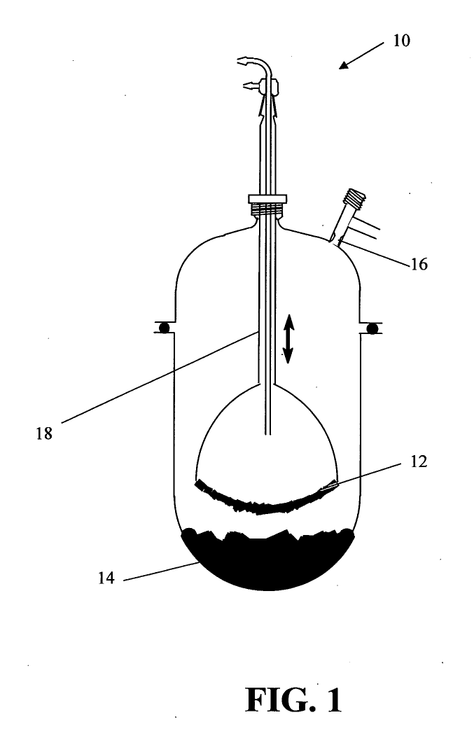

Turning now to the drawings, FIG. 1 shows one possible embodiment of an adjustable path sublimator 10 where the distance between the sublimating surface 12 and the starting material 14 can be adjusted depending on the amount of starting material 14 remaining at the bottom of the sublimator 10 and the rate of sublimation. There is a condenser 18 connected to the sublimating surface 12. There is also a pressure port 16 located near the top of the sublimator 10 which is used to control the pressure within the sublimator 10. The adjustable path sublimator 10 may be made from borosilicate glass. A vacuum hose (not shown) may be attached to the pressure port 16 to help control the pressure within the sublimator 10. A coolant supply hose (not shown) and a coolant return hose (not shown) may be attached to the condenser 18 for circulating coolant within the condenser 18.

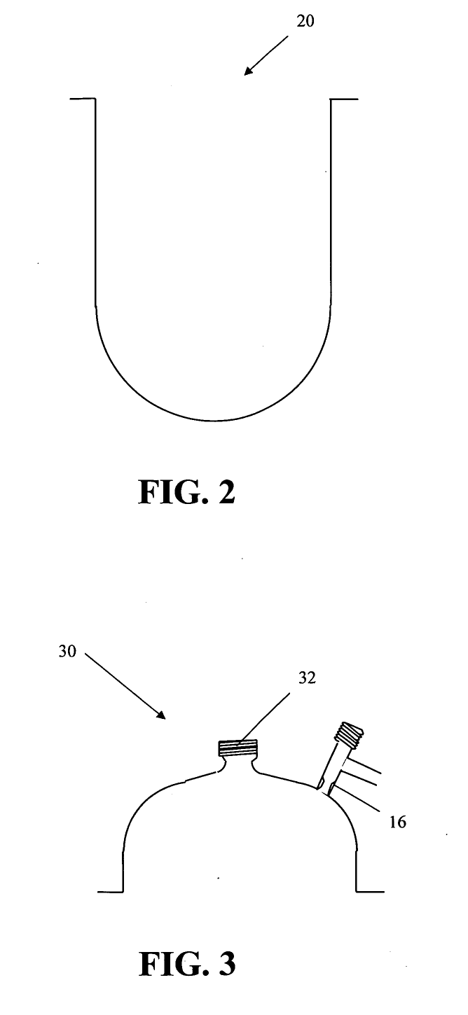

FIG. 2 shows one possible embodiment of the lower vessel 20 of the adjustable path sublimator 10. The lower vessel 20 may be fabricated by closing a 5.5″ o-ring flange with a rounded bottom. It should be appreciated that the lower vessel may have other desired or required dimensions, contours, or shapes that may be utilized.

FIG. 3 shows one possible embodiment of the upper vessel 30 (also called a cap assembly) of the adjustable path sublimator 10. The upper vessel 30 has a threaded connector 32 where a condenser 18 can be inserted into the adjustable path sublimator 10. The upper vessel 30 also has a pressure port 16 for controlling the pressure within the adjustable path sublimator 10. The upper vessel 30 may be fabricated by altering a 5.5″ o-ring flange to have a #25 o-ring connector (as the threaded connector 32) attached on axis and a 0-8 mm stopcock barrel (as a pressure port 16) attached off axis. It should be appreciated that the upper vessel may have other desired or required dimensions, contours, or shapes that may be utilized.

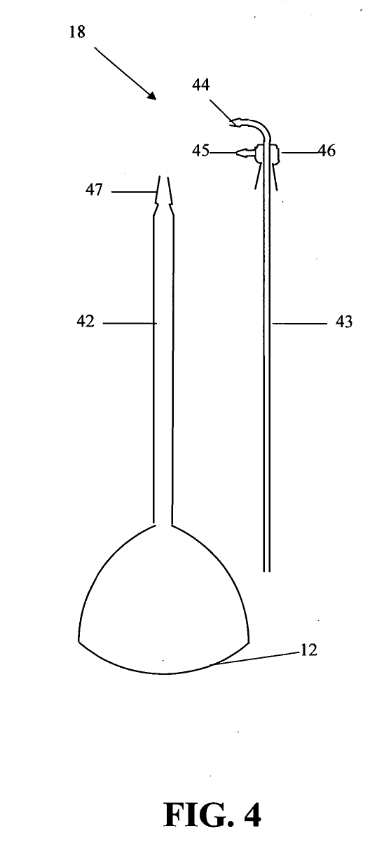

FIG. 4 shows one possible embodiment of the condenser 18 of the adjustable path sublimator 10. The condenser 18 consists of several parts. The sublimating surface 12 is connected to an outer tube 42. The outer tube is attached to a hose connector 44. The hose connector consists of two parts an outer joint 46 and an inner joint 47. An inner tube 43, which will eventually be inserted into the outer tube 42, passes through the outer joint 46 and also has a hose connector 45 at the open end. The condenser 18 may be fabricated by sealing a 25 mm tubing to a 300 ml flask or container, or other volumes as desired or required. The 300 ml flask is altered from a spherical bottom to a less rounded bottom, such that the less rounded bottom will work as the sublimating surface 12. A 24/40 inner ground joint is sealed to other end of 25 mm tubing. A 9 mm tubing is ring-sealed through a 24/40 outer ground joint on axis. A small hose connection is attached to the 9 mm tubing on axis and bent 90 degrees. A second hose connection is sealed to the tubing of 24/40 outer ground joint. It should be appreciated that the joints and tubings may be any desired dimension or contours. Furthermore, any other available conduit may be utilized to achieve its intended purpose.

The lower vessel 20, upper vessel 30, and condenser 18 of the adjustable path sublimator 10 depicted in FIGS. 2, 3, and 4 may be assembled into the adjustable path sublimator depicted in FIG. 1. The condenser 18 slides through the threaded connector 32 from the concave side. A #212 o-ring and a #25 nylon bushing are then added. The bushing is screwed into the threaded connector 32. The 24/40 outer ground joint is inserted into the condenser 18. A clamp #24 is added. A stopcock is inserted into the pressure port 16. A #359 o-ring is placed between the flanges and clamp. It should be appreciated that the o-rings, bushing, or joints may be any desired or required dimension or contour. Furthermore, any other available connecting means or devices may be utilized to achieve its intended purpose.

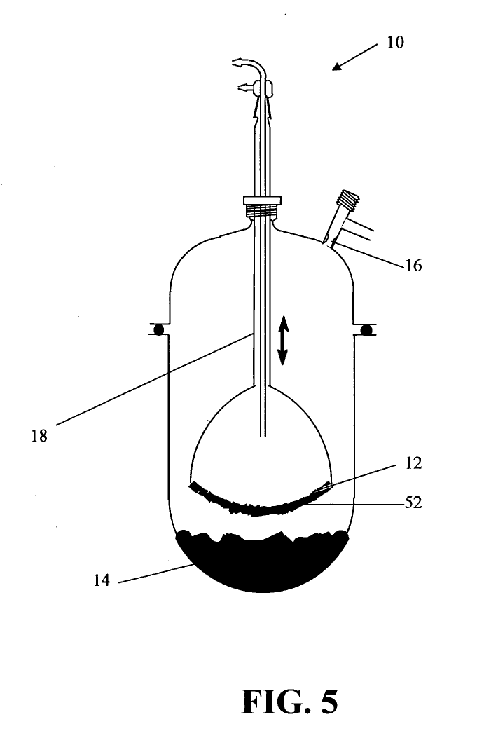

FIG. 5 shows one possible embodiment of the adjustable path sublimator 10 at the beginning of the sublimation process. The adjustable path sublimator 10 is placed on a heating mantel (not shown) and coolant is flowing through the condenser 18. Pressure within the adjustable path sublimator 10 is being adjusted through the pressure port 16. As the starting material 14 is heated, the sublimate 52 begins to accumulate on the sublimating surface 12.

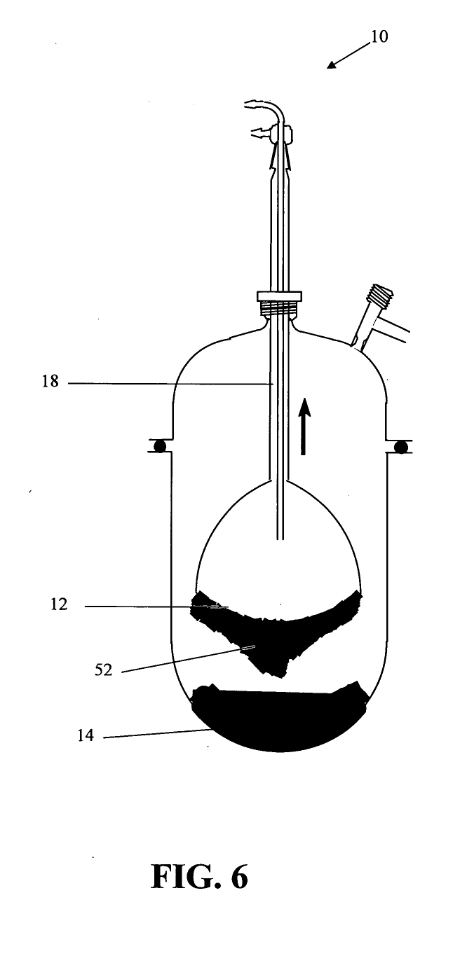

FIG. 6 shows one possible embodiment of the adjustable path sublimator 10 at a later stage of the sublimation process. The sublimate has thickened on the sublimating surface 12 and the condenser 18 has been adjusted so that the sublimate 52 does not come in contact with the starting material 14. All of this has been done without stopping the sublimation process or compromising the integrity of the sublimation environment. Furthermore, these dynamic adjustments during the sublimation process allow for increased and sustained yield without risk of contamination to the sublimate 52.

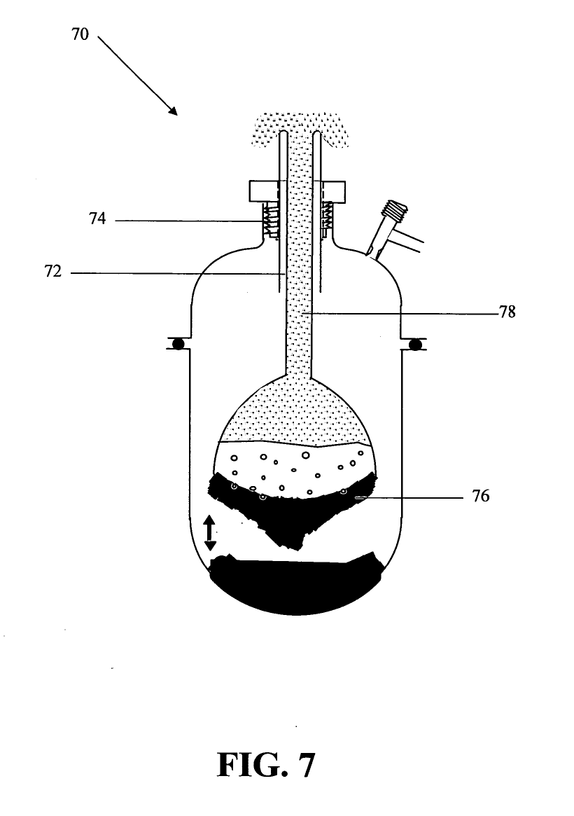

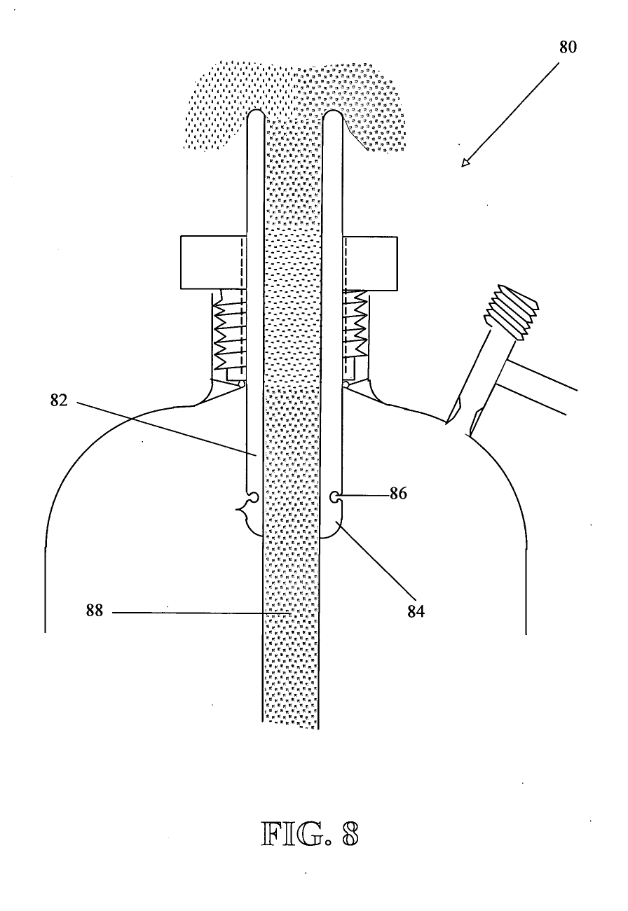

FIG. 7 shows another possible embodiment of an adjustable path sublimator 70 for use with cryogenic sublimation. A double wall 72 can be used to insulate the vacuum sealing surface 74 (o-ring in drawing) from the cold surface 76 of the cold finger 78. This is to keep the o-ring or vacuum sealing surface 74 pliable and able to maintain the vacuum without leaking during cold finger 78 adjustment.

FIG. 8 shows another possible embodiment of an adjustable path sublimator 80 for use with cryogenic sublimation. This double wall 82 can either use the inherent vacuum of the system or consist of a separate chamber which may be silvered 84 and evacuated as a dewar would be. There are also bellows 86 which provide stress relief from the disparity in temperature in the cold finger 88 and the temperature in the adjustable sublimator 80 itself.

One skilled in the art can see that many other embodiments of the adjustable path sublimator may be implemented using various materials, sizes, contours and dimensions. For example, in addition to glass, the fabricating material for the adjustable path sublimator can be a variety of materials, such as metals, ceramic, polymer or any combination thereof. Metals, include, but are not limited to, stainless steel and monel metal. These materials can lower the cost in an industrial setting, increase the durability and protect the material being sublimated from light if it is light sensitive in nature. In addition, the fabricating material can be made of metal coated or metal covered glass, which would combine the advantages of glass and metal together. Furthermore, metal coated glass and metallic conducting surface can also be used to electrically bias the material being sublimated with an opposite bias to the metallic cold finger or metal coated glass sublimation correction surface. This would help to accumulate the charged particle to be sublimated preferentially, if the need arises.

We claim:

1. A sublimator device, wherein said device comprises:
a vessel that contains the starting material disposed therein;
a heat source for heating the starting material;
a sublimating surface within said vessel for collecting sublimate of the material;
a port disposed on said vessel for controlling pressure within said vessel; and
said sublimating surface and said vessel are in movable relation to one another, wherein the moveable relationship allows said sublimating surface from making contact with the starting material in said vessel without interrupting the sublimation process and allowing for increased and sustained yields without risk of contamination.

2. The device of claim 1, wherein said sublimating surface is adapted to move away from said starting material while said vessel remains stationary.

3. The device of claim 1, wherein said starting material within said vessel is adapted to move away from said sublimating surface while said sublimating surface remains stationary.

4. The device of claim 1, wherein said sublimating surface is adapted to move away from said starting material and said starting material within said vessel is adapted to move away from said sublimating surface while said vessel and said sublimating surface are in motion.

5. The device of claim 1, further comprising a condenser at least partially disposed within said vessel and attached to said sublimating surface for circulating coolant.

6. The device of claim 5, wherein said vessel comprises:
a lower vessel for holding the starting material; and
an upper vessel for inserting said condenser, said lower vessel and said upper vessel connectable to one another.

7. The device of claim 6, wherein said lower vessel is an o-ring flange closed with a rounded bottom.

8. The device of claim 6, wherein said upper vessel is an o-ring flange attached with an o-ring connector on axis for inserting said condenser into said vessel.

9. The device of claim 1, wherein said sublimating surface is the bottom of a flask, tube, or container.

10. The device of claim 5, wherein said condenser comprises:
an outer tubing attached to said sublimating surface; and
an inner tubing inserted into said outer tubing.

11. The device of claim 10, wherein said outer tubing is sealed to an inner ground joint to accommodate the insertion of said inner tubing.

12. The device of claim 10, wherein said inner tubing is sealed to an outer ground joint to accommodate said inner tubing being inserted into said outer tubing.

13. The device of claim 12, wherein said outer ground joint is sealed to a hose connection.

14. The device of claim 10, wherein said inner tubing is attached to a hose connector.

15. The device of claim 5, wherein said condenser is a cryogenic cold finger.

16. The device of claim 15, wherein said cryogenic cold finger comprises a double wall for insulating the vacuum sealing surface of said vessel from rising cold vapors.

17. The device of claim 16, wherein said double wall contains bellows for providing stress relief from temperature disparities.

18. The device of claim 17, wherein said double wall contains a separate chamber for improving insulation.

19. The device of claim 18, wherein said separate chamber comprises a liner.

20. A method for sublimating a suitable starting material, wherein said method comprises:
disposing the starting material into a vessel;
heating the starting material;
controlling the heat applied to the starting material; and
collecting the sublimate produced from the heated starting material onto a sublimating surface, wherein said collected sublimate avoids contact with the starting material in said vessel without stopping the sublimation process or compromising the integrity of the sublimation environment.

21. The method of claim 20, further comprises circulating coolant to said sublimating surface.

22. The method of claim 20, further comprises controlling pressure within said vessel.

23. The method of claim 20, further comprises moving said sublimate away from said starting material while said vessel remains stationary.

24. The method of claim 20, further comprises moving said starting material away from said sublimate while said sublimating surface remains stationary.

25. The method of claim 20, further comprises moving said sublimate away from said starting material and moving said starting material away from said sublimate while said sublimating surface and said vessel are in motion.
